(19) United States
(12) Patent Application Publication
(10) Pub. No.: US 2008/0075599 A1
(43) Pub. Date: Mar. 27, 2008

(54) FLUID ENERGY CONVERTER

(75) Inventor: Donald C. Miller, Fallbrook, CA (US)

Correspondence Address: KNOBBE MARTENS OLSON & BEAR LLP, 2040 MAIN STREET, FOURTEENTH FLOOR, IRVINE, CA, 92614, US

(73) Assignee: Fallbrook Technologies Inc., San Diego, CA (US)

(21) Appl. No.: 11/746,482

(22) Filed: May 9, 2007

Related U.S. Application Data
(60) Provisional application No. 60/799,259, filed on May 10, 2006.
(60) Provisional application No. 60/864,943, filed on Nov. 8, 2006.

(51) Int. Cl. F03D 3/06

(52) U.S. Cl. 416/182; 416/227 R

(57) ABSTRACT

A fluid energy converter, such as windmill or a wind turbine, includes a rotor having a front rotatable hub and a back rotatable hub. In some embodiments, a plurality of blades extend from the front hub to the back hub. A suitable blade includes a front section, a tip, and a back section. In one embodiment, the chord of the tip cross section is at an angle relative to the tangent of the rotor radius. The tip chord can be perpendicular to the direction of movement of the fluid. In some cases, the profile of a blade front section, from its root to the tip, forms a concave curve. In one case, the profile of the blade tip, from a junction root to the tip, forms a convex curve. A front section, an apex, and a back section of a blade form a generally parabolic shape.

### RELATED APPLICATIONS

This application claims priority to U.S. Provisional Patent Applications 60/799,259 and 60/864,943 filed, respectively, on May 10, 2006 and Nov. 8, 2006.

### BACKGROUND OF THE INVENTION

1. Field of the Invention

The field of the invention relates generally to fluid energy converters, and more particularly the invention relates to windmills and wind turbines.

2. Description of the Related Art

Fluid energy converters typically use blades, propellers, or impellers to convert kinetic energy of a moving fluid into mechanical energy, or to convert mechanical energy into kinetic energy of a moving fluid stream. For example, windmills and waterwheels convert kinetic energy from the wind or water into rotating mechanical energy, and wind turbines and water turbines further employ a generator to convert the rotating mechanical energy into electrical energy. In the reverse process, fans, propellers, compressors, and pumps can be configured to impart kinetic energy, from rotating mechanical energy, to a fluid.

Energy conversion, from kinetic to mechanical, for gases can be inefficient, especially with windmills and wind turbines. It is generally accepted that the highest efficiency possible for devices converting kinetic energy from the wind is about 59.3%. However, this number neglects losses which occur from drag and turbulence, for example. Some utility class three blade wind turbines can achieve peak efficiencies from 40-50%, while windmills are significantly lower. Therefore, there exists a need for a more efficient fluid energy converter for wind applications.

While some fluid energy converters for use with liquid fluids can achieve high efficiencies, these machines are expensive. For example, although Francis water turbines can achieve efficiencies of over 90%, they are extremely expensive. Applications exist where cost is a more important factor than efficiency maximization, and thus there exists a need for a lower cost fluid energy converter for liquid flows that still maintains a desirable efficiency.

### SUMMARY OF CERTAIN INVENTIVE EMBODIMENTS OF THE INVENTION

The systems and methods illustrated and described herein have several features, no single one of which is solely responsible for its desirable attributes. Without limiting the scope as expressed by the description that follows, its more prominent features will now be discussed briefly. After considering this discussion, and particularly after reading the section entitled “Detailed Description of the Preferred Embodiments” one will understand how the features of the system and methods provide several advantages over traditional systems and methods.

In one aspect, the invention relates to a rotor with multiple blades for a fluid energy converter. The rotor is further comprised of a front hub and a back hub. The blades can have a small diameter at a front section, where they are attached to the front section, with the diameter increasing to its maximum at the tip, then decreasing at the back section, which is attached to the back hub. The blades can be provided with multiple pitches to maximize capturing kinetic energy of a fluid stream as the fluid stream rotates the blades about the longitudinal axis.

In another aspect, the invention concerns a fluid energy converter having a longitudinal axis and a rotatable rotor about the longitudinal axis. The rotatable rotor can have multiple blades for converting rotating mechanical energy into kinetic energy in a fluid. In one embodiment, the tip is bent to augment its power producing capability. In another embodiment, the blades are flexible and adapted to bend as the angular velocity of the rotor changes.

In yet another aspect, the invention relates to a rotor for a fluid energy converter. The rotor can have multiple blades for converting rotating mechanical energy into kinetic energy in a fluid. The blades can be elongated, curving structures comprised of a front section, a tip, and a back section. The blades can be attached at the root of the front section to a front hub and at the root of the back section to a back hub. The profile of the front section can be a concave curve and the profile of the tip can be a convex curve.

In still another aspect, the invention concerns a fluid energy converter having a longitudinal axis and a rotatable rotor comprised of a plurality of blades about the longitudinal axis. The fluid energy converter can further include a tail to maintain a desired direction of the rotor relative to the fluid stream, a nacelle to house a drivetrain and motor/generator, and a tower to support the rotor, nacelle, and tail. The fluid energy converter can also include a shaft coincident with the longitudinal axis and operationally coupled to the rotatable rotor. The blades can be made from a material that is of uniform thickness and have airfoil curves formed into their surfaces. In some configurations, the rotatable rotor converts kinetic energy in a fluid into rotating mechanical energy, or converts rotating mechanical energy into kinetic energy in a fluid.

In another embodiment, the tips of the blades are folded over to produce a bend at the largest diameter of the blades, thereby increasing the surface area of the blades at the tip.

Another aspect of the invention is directed to a rotor for a fluid energy converter. The rotor comprises a longitudinal axis, a front rotatable hub coaxial with the longitudinal axis, and a back rotatable hub coaxial with the longitudinal axis. The fluid energy converter can additionally include a plurality of blades, each blade comprising a back end, a front end, a front section, a tip, and a back section. The blades can be arrayed angularly about the longitudinal axis, and each blade is attached at the front end to the front hub and attached at the back end to the back hub.

Yet another aspect of the invention concerns a rotor for a fluid energy converter. The rotor includes a longitudinal axis, a front rotatable hub coaxial with the longitudinal axis, and a back rotatable hub coaxial with the longitudinal axis. The rotor can additionally have a plurality of blades, each blade attached at a front end to the front hub and attached at a back end to the back hub; the blades can be positioned radially around the longitudinal axis, and at least some of the blades have a front section, a tip, and a back section. In some embodiments, the tip is bent at an angle between 70 and 110 degrees from a line forming the radius of the rotor.

A different aspect of the invention addresses a rotor for a fluid energy converter. The rotor has a longitudinal axis, a front rotatable hub coaxial with the longitudinal axis, and a back rotatable hub coaxial with the longitudinal axis. In one example, the fluid energy converter is provides with a plurality of blades, each blade attached at a front end to the front hub and attached at a back end to the back hub; the blades can be positioned radially around the longitudinal axis, and each blade can have a front section, a tip, and a back section. For some applications, the chord of the tip cross section is at an angle relative to the tangent of the rotor radius.

One more aspect of the invention relates to a fluid energy converter having a longitudinal axis and a rotatable rotor coaxial about the longitudinal axis, wherein the rotatable rotor includes a plurality of blades, each blade comprised of a front section, a tip, and a back section. In one embodiment, the tip chord is perpendicular to the direction of the movement of the fluid.

Still another aspect of the invention is directed to a fluid energy converter having a longitudinal axis, a rotatable front hub coaxial with the longitudinal axis, and a rotatable back hub coaxial with the longitudinal axis. The fluid energy converter can include a shaft coincident with the longitudinal axis and a plurality of blades coaxial about the longitudinal axis. A suitable blade for such an application preferably has a front section attached at its root to the front hub, a back section attached at its root to the back hub, and a tip defining the largest diameter of the rotor. In some cases, the profile of the front section from its root to the tip forms a concave curve.

Yet one more aspect of the invention concerns a fluid energy converter rotor having a longitudinal axis, a rotatable front hub coaxial with the longitudinal axis, and a rotatable back hub coaxial with the longitudinal axis. The rotor can have a shaft coaxial with the longitudinal axis and at least three blades coaxial about the longitudinal axis. A blade configured for use in such rotor preferably includes a front section, the front section attached at its root to the front hub; a back section, the back section attached at its root to the back hub; and a tip, the tip of the blade forming the largest diameter of the rotor. In one case, the profile of the tip from its junction root to the tip forms a convex curve.

Another aspect of the invention is directed to a rotor blade having a front section, an apex, and a back section. In one embodiment, the front section, the apex, and the back section are configured to form a generally parabolic shape. Yet a different aspect of the invention relates to a rotor blade having a front section, a tip flap, and a back section.

These and other improvements will become apparent to those skilled in the art as they read the following detailed description and view the enclosed figures.

### BRIEF DESCRIPTION OF THE DRAWINGS

FIG. 1 is a perspective view of a fluid energy converter.

FIG. 2 is a partial section view of the fluid energy converter of FIG. 1.

FIG. 3 is another partial section view of the fluid energy converter of FIG. 1.

FIG. 4A is a perspective view of a blade that can be used with the fluid energy converter of FIG. 1.

FIG. 4B is another perspective view of a blade that can be used with the fluid energy converter of FIG. 1.

FIG. 4C is a top view of a blade that can be used with the fluid energy converter of FIG. 1.

FIG. 5A is a perspective view of a front section profile of the blade of the fluid energy converter of FIG. 1.

FIG. 5B is a perspective view of a tip profile of the blade of the fluid energy converter of FIG. 1.

FIG. 5C is a perspective view of the back section profile of the blade of the fluid energy converter of FIG. 1.

FIG. 6 is a schematic of certain fluid dynamics believed to be associated with the fluid energy converter of FIG. 1.

FIG. 7 is a schematic of a rotor, of the fluid energy converter of FIG. 1, pitched down.

FIG. 8 is a schematic of a rotor, of the fluid energy converter of FIG. 1, pitched up.

FIG. 9 is a front view of the fluid energy converter of FIG. 1 having a rotor yawed in a first direction.

FIG. 10 is a front view of the fluid energy converter of FIG. 1 having a rotor yawed in a second direction.

FIG. 11 is a perspective view of a rotor, of the fluid energy converter of FIG. 1, pitched and yawed.

FIG. 12 is a schematic cross sectional top view of the profile of the blade of the fluid energy converter of FIG. 1.

FIG. 13 is a schematic cross sectional front view of the profile of the blade of the fluid energy converter of FIG. 1.

FIG. 14 is a back view of a rotor of the fluid energy converter of FIG. 1.

FIG. 15 is a section view of the fluid energy converter of FIG. 1 having a continuously variable variator unit.

FIG. 16A is a front partial view of a nacelle, of the fluid energy converter of FIG. 1, showing the effect of the nacelle on the fluid that enters the fluid energy converter.

FIG. 16B is a perspective partial view of the nacelle of FIG. 16A and the effect of the nacelle on fluid that enters the fluid energy converter of FIG. 1.

FIG. 17 is a perspective view of an alternative blade that can be used with a fluid energy converter.

### DETAILED DESCRIPTION OF CERTAIN INVENTIVE EMBODIMENTS

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

This application hereby incorporates herein by reference in their entireties the following U.S. patent application Ser. Nos. 11/506,762, filed on Aug. 18, 2006; 60/864,943, filed on Nov. 8, 2006; and 60/799,259, filed on May 10, 2006.

In a first aspect, a fluid turbine can have a rotatable rotor and a stand or tower. The rotor includes a longitudinal axis, a plurality of rotatable blades concentric with the longitudinal axis, a rotatable front hub concentric with the longitudinal axis, a nacelle concentric with the longitudinal axis, a rotatable back hub concentric with the longitudinal axis, and a shaft concentric with the longitudinal axis. In one embodiment, each blade incorporates a front section, a tip, and a back section.

For each blade, the root of the front section attaches to the front hub and the root of the back section attaches to the back hub. In some embodiments, the front hub and the back hub rotate over the shaft on bearings to minimize friction. The nacelle can be rigidly attached to the shaft and can have multiple helical vanes on its outer surface. The shaft can be a rigid rod or a hollow tube and attaches to the tower supporting the rotor. In one embodiment, the nacelle houses a drivetrain, which can include a speed increaser and a generator to produce electricity. In some embodiments, a tail is positioned behind and attached to the rotor, which tail is directed by the fluid stream to point the rotor into the fluid stream. The tail can have both vertical plane and horizontal plane components, which serve to position the rotor both in pitch and yaw.

In some embodiments, areas of high and low pressure are created when some fluids pass through the rotor. The fluid contacts the root of the front section of the blades as it approaches the rotor and is projected radially away from the longitudinal axis and compressed against the tip and the outer portion of the front and back sections of the blades, creating an area of high pressure relative to the surrounding fluid pressure. An area of low pressure forms near and around the longitudinal axis, and consequently, draws the fluid into the rotor. In this manner, the area of low pressure accelerates the fluid across and through the rotor. Additionally, fluid tangent to the fluid entering the rotor is directed against the outside surface of the tip and the outer portion of the front and back sections of the blades, thereby creating an area of high pressure on both the inside and outside surfaces of the tip and outer portion of the front and back sections of the blades.

In some conditions the rotor can be pitched (that is, oriented up or down in a vertical plane) and/or yawed (that is, rotated from side to side on a horizontal plane) to take advantage of beneficial effects which increase power production. The nacelle can incorporate helical vanes which direct the fluid to rotate in the same direction as the rotation of the rotor, creating a vortex and increasing power production. In another aspect, the blade tips are folded over, to increase their surface area and power producing capability.

In another aspect, the drivetrain of the rotor incorporates a continuously variable transmission (CVT) to maintain a substantially constant speed into the generator as the velocity of the fluid, such as air or water, varies. The CVT can be located in front of the generator or, if a speed increaser is used, between the speed increaser and the generator, and can provide the additional benefit of cushioning the generator from torque spikes due to sudden increases in fluid flow, such as wind gusts. The input of the CVT is connected to the output of the speed increaser and the output of the CVT is attached to the input of the generator. In some embodiments, the speed increaser can be of the type described in Patent Cooperation Treaty patent application publication WO 2006/014617.

In some embodiments where a CVT is incorporated into the drivetrain, the CVT and generator are integrated. This can be accomplished by using a ball type CVT, which can be CVT embodiments disclosed in U.S. Pat. Nos. 6,241,636; 6,419,608; and 6,689,012, which are all hereby incorporated herein by reference in their entireties. The stator of the generator, which is usually stationary, can be attached to the sun (or idler, or support member) of the CVT. The generator rotor can be attached to the output ring of the CVT and rotates in the opposite direction of the sun. This creates a large speed differential between the stator and the rotor, which rotate in opposite directions, and increases generator power density. Alternatively, the integral CVT/generator can eliminate one or more stages of the speed increaser. The integral CVT/generator eliminates the shaft and couplers that connect the CVT to the generator, two or more bearings, and one of the cases surrounding the CVT and generator. Also, in a permanent magnet generator, the magnets can be attached to the same steel that forms the output ring of the CVT.

In yet another aspect, if a ball type CVT is used that is also functionally a planetary gearset, the CVT can also function as a generator, eliminating the generator. In such an embodiment, the balls (or power rollers) in the CVT can be made from magnetic material, such as hard ferrite ceramic or neodymium boron iron. As the input ring of the CVT rotates the multiple balls, the magnetic poles of the balls pass by copper, aluminum, or silver wires attached to the structure holding the balls in place, and electricity is produced. Additionally, a large speed increase is achieved due to the smaller diameter balls being rotated by the larger input ring. This speed increase can eliminate one or more stages of the speed increaser.

In some embodiments, the fluid energy converter is configured so that the pitch of the front section of the blades is greater than the pitch of the back section. In this manner, the swirl behind the front section approaches the back section at an appropriate angle for power extraction. In some embodiments, the nacelle can be adapted to redirect the fluid in a beneficial direction, in which case the pitch of the back section of the blades can be greater. In some embodiments the back section of the blades are designed to direct the fluid radially away from the longitudinal axis as the fluid exits the back of the rotor. This increases the low pressure near the longitudinal axis and directly behind the rotor, increasing fluid draw into the rotor. In other embodiments the back section of the blades are configured to straighten the fluid exiting the rotor and reentering the fluid stream. This minimizes turbulence created from surrounding fluid mixing with fluid that has passed through or adjacent to the rotor. In some embodiments, the nacelle is moved forward toward the front of the rotor, to minimize the time the swirl rotates in a power reducing direction. In still other embodiments, the helical vanes of the nacelle, which direct or redirect fluid, are not used.

In still another aspect, the tail can be offset from the longitudinal axis to set the optimal pitch and yaw relative to the fluid stream. Thus, the tail axis need not be parallel with the longitudinal axis. In some embodiments, changing fluid velocity increases or decreases pressure on the tail, causing changes in pitch and yaw with varying fluid speeds.

In still another embodiment, the blades of the rotor are designed to flex so that the pitch of the blades will vary with changes in fluid velocity. In one aspect, the power train is attached to the back hub, and the front hub of the rotor is configured to spin freely. In such embodiments, the pitch of the blades can be arranged to change as pressure applied to the blades by the fluid varies with changes in fluid velocity.

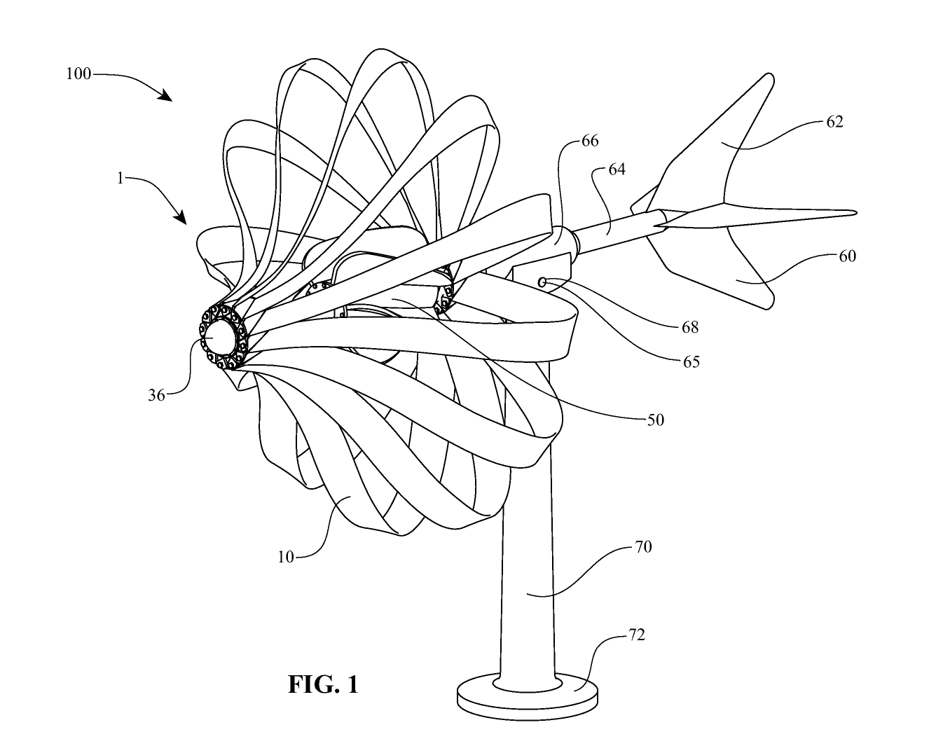

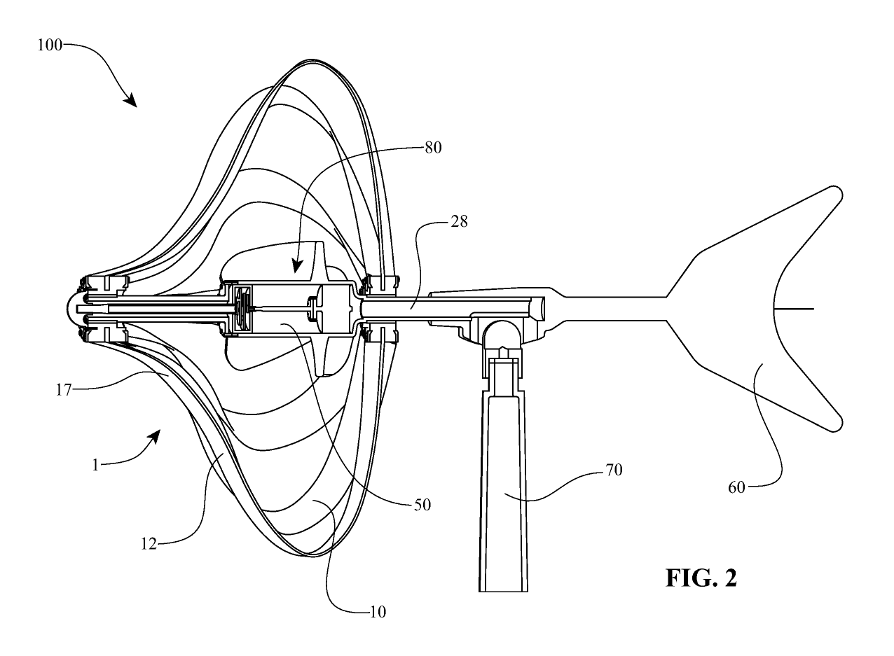

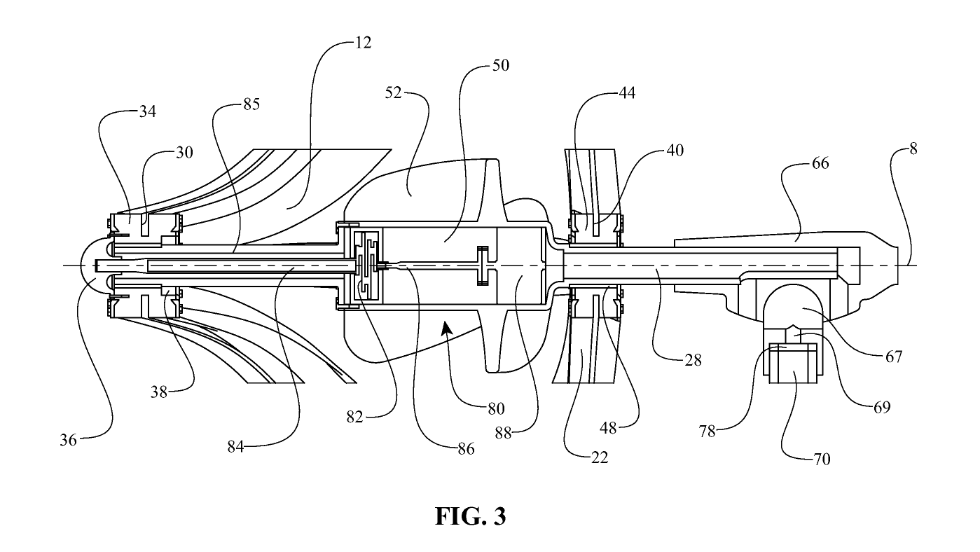

Referring now to FIGS. 1, 2, and 3, one embodiment of a fluid energy converter 100 is shown. The fluid energy converter 100 includes a rotor 1, a power train 80, a tail 60, and a tower 70. In one embodiment, the rotor 1 can have a plurality of blades 10, a front hub 34, a back hub 44, a nacelle 50, and a shaft 28. In some embodiments, the blades 10 can be generally curving structures with one or more fluid foils formed into their surfaces. Depending on the size and the desired strength-to-weight ratio, the blades 10 can be produced from materials such as sheet metal, composites (including carbon fiber, fiberglass and polyester resin), plastic, or any other suitable material.

In some embodiments, the length-to-diameter ratio of the rotor 1 is about 0.8:1, although this ratio can vary according to the application, and can range from about 1:10 to about 10:1. In embodiments where the fluid energy converter 100 produces energy, the blades 10 are preferably configured to capture kinetic energy of a moving fluid, such as air or water, and convert the captured kinetic energy into rotating mechanical energy. In embodiments where the fluid energy converter 100 moves a fluid, such as in a compressor or pump, the blades 10 are preferably adapted to direct the fluid in a desired direction. In some embodiments, the blades 10 can be configured to compress and/or accelerate the movement of the fluid. As used here, when referring to the interaction between a fluid or fluid stream and the blades 10 (or rotor 1), the term “capture” refers to a resistance provided by the blades 10 or rotor 1 that, among other things, increases the volume of fluid entering the rotor 1 and/or increases the transfer of kinetic energy from the fluid to the rotor 1.

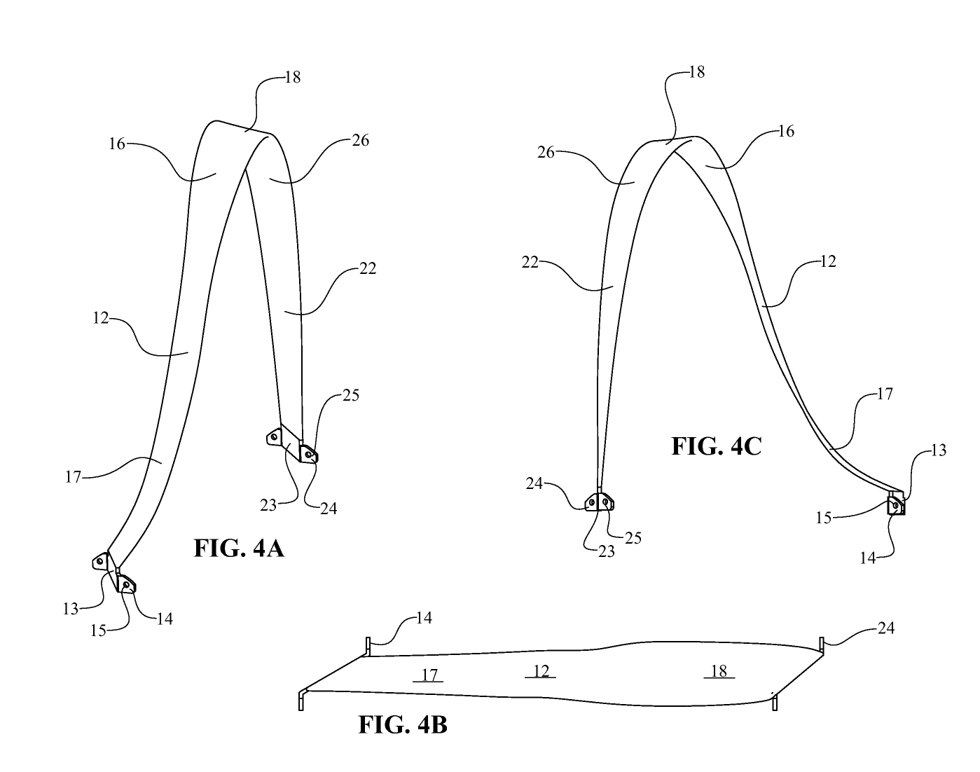

Referring now to FIGS. 1-5C, one embodiment of the blades 10 is described. The blades 10 are generally long, slender, curving shapes that are attached at a front end and a back end, respectively, to the front hub 34 and the back hub 44. The blades 10 can be curved to maximize energy production in a fluid energy converter 100 that converts the kinetic energy in a fluid to rotating mechanical energy, or to optimize directing fluid when the fluid energy converter 100 converts rotating mechanical energy to kinetic energy in a fluid. In some embodiments, the front section 12 of each blade 10 has a front curve 17, where an averaged center (not shown) of the front curve 17 is positioned toward the front of the blade 10 and radially away from the longitudinal axis 8. In some embodiments, the front curve 17 is not a single radius and, rather, is formed from multiple radii. In one embodiment, a convex side of the front curve 17 faces toward the longitudinal axis 8 and the back of the rotor 1, while the concave side of the front curve 17 faces toward the averaged center. In some embodiments, the pitch of the front section 12 varies from the front root attachment 13 to the front transition 16 near the tip 18 to account for changes in the angular velocity of the blade 10. In some embodiments, the pitch of the front transition 16 can be 30 degrees, while the pitch of the front root attachment 13 can be 50 degrees. In other embodiments, the pitch and the twist of the front section 12 will vary according to the application. In some embodiments, the back section 22 can include a back transition 26 with a pitch of 20 degrees, while the pitch of the back root attachment 23 can be 40 degrees. In some embodiments the twist, or change in pitch is linear from the front transition 16 to the front root attachment 13, and from the back transition 26 to the back root attachment 23. In other embodiments, the twist is non-linear and increases toward the front root attachment 13 and the back root attachment 23. In applications with high angular velocities, the pitch of the blades 10 will generally be less, can approach zero degrees, and in some cases can be negative. For example, in a wind turbine with a high angular velocity, the pitch of the front transition 16 can be zero degrees and the pitch of the back transition 26 can be negative 10 degrees. In embodiments with low angular velocities and/or different fluids, the pitch of the blades 10 can be greater than 60 degrees. In some embodiments, the front section 12 and the back section 22 the same pitch, while in other applications the pitch of the back section 22 is greater than the pitch of the front section 12. In some embodiments, such as wind turbines, the pitch of the back section 22 can be 10 degrees less than the pitch of the front section 12.

Still referring to FIGS. 1-5C, each blade 10 is composed of a front root attachment 13, a front section 12, a tip 18, a back section 22, and a back root attachment 23. The front root attachment 13 is used to attach each blade 10 to the front hub 34 and includes one or more front tabs 14. In some embodiments, the front tabs 14 can have one or more front holes 15 through which a standard fastener (not shown) is inserted to attach the blade 10 to the front hub 34. In some embodiments, two front tabs 14 are used, one to attach the blade 10 to the front of the front hub 34 and the other to attach the blade 10 to the back of the front hub 34. In some embodiments, the front hub 34 and the back hub 44 are similar, although in some applications the nacelle 50 is located at the front of the rotor 1, thereby necessitating a different configuration for the front hub 34. In some embodiments, the back root attachment 23 uses the same method to attach the back section 22 to the back hub 44. Two back tabs 24, each having one or more back holes 25 are configured to provide an attachment to the back hub 44.

The front hub 34 and the back hub 44 are generally cylindrical tubes, each having a bore in the center to allow the insertion of a front bearing 38 in the front hub 34 and a back bearing 48 in the back hub 44. The front hub 34 and the back hubs 44 are rigid, load carrying components, and depending on the application can be made from metal, such as aluminum and steel, plastic (including plastics which can be molded), composite material (such as carbon fiber), or any other suitable material. The front hub 34 and the back hub 44 can have a plurality of front and back slots 30, 40, which can be cut into the hubs 34, 44, at the same angle as the front root attachment 13 and the back root attachment 23. The root attachments 13, 23, can be inserted into the slots 30, 40, and secured with standard fasteners which are threaded into the hub holes 32, 42. In some embodiments the hub holes 32, 42 are not threaded but provide clearance for bolts (not shown) which extend from the first of the front and back tabs 14, 24, through the hub holes 32, 42, and finally through the second front and back tabs 14, 24. In some embodiments, nuts and lock washers (not shown) are used to tighten and secure the bolts.

Still referring to FIGS. 1-5C, the front transition 16 denotes the transition from the front section 12 to the tip 18. The twist of the pitch continues to the outermost portion of the tip 18 where the pitch in some embodiments is zero degrees. In some embodiments, the chord at the outermost portion (the portion defining the outside diameter of the rotor 1) of the tip 18 is not tangent to a circle defining the outside diameter of the rotor 1, but is offset at an angle to this tangent. As used here, the term “tangential pitch” refers to the chord angle relative to the tangent of the circle defined by the outermost portion of the tip 18. The tangential pitch produces lift on a plane that is 90 degrees to the plane of the lift produced by the pitch. A tangential pitch with a negative angle denotes a chord with a profile that has a leading edge radially inside of the circle and a trailing edge outside of the circle. In some embodiments, the tip 18 has a tangential pitch of −6 degrees, which denotes a chord that points slightly toward the center of the rotor 1. This negative angle creates lift in a direction that is both radially out from the center and tangentially in the direction of rotation. The tangential component of the lift pulls the rotor 1 in the direction of rotation, adding power to the rotor 1 when the fluid energy converter 100 is configured to convert kinetic energy in a fluid to rotating mechanical energy.

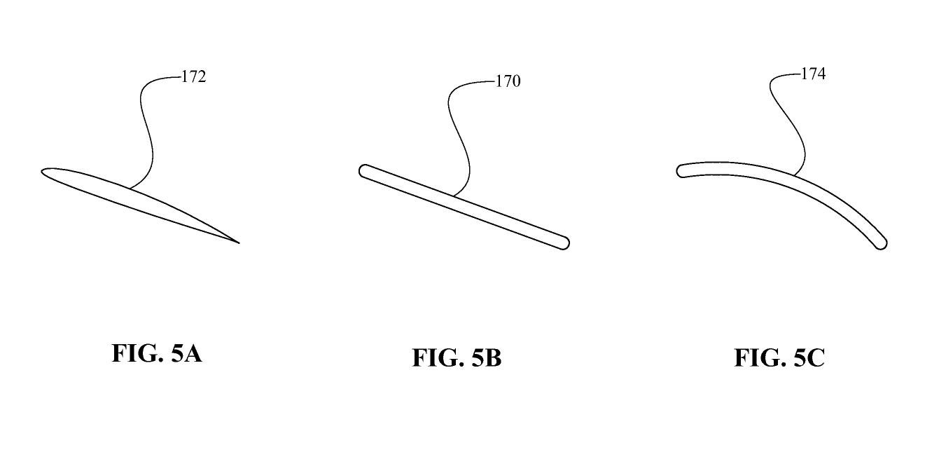

Still referring to FIGS. 1-5C, the fluid foils of the blades 10 are described. In some embodiments the foils of the front section 12, tip 18, and back section 22, can be different to account for differences in angular velocity from the root attachments 13, 23, to the tip 18, and also to augment power extraction by the fluid energy converter 100 in important areas, such as the tip 18. In some embodiments, a different foil can be used at the root attachments 13, 23, than at the front and back transitions 16, 26. In some embodiments, the front section 12 near the front root attachment 13 uses a flat, plate style foil 170 with rounded edges like the profile shown in FIG. 5B. At the front transition 16, the tip 18, and the back transition 26, the foil can change to a typical fluid foil 172 like that shown in FIG. 5A to account for the increase in angular velocity. Near the back root attachment 23, the fluid foil can change again to a curved foil 174 shown in FIG. 5C.

The profiles of the fluid foils 170, 172, 174 can vary depending on the angular velocity of the fluid energy converter 100, the fluid, the size, and the application. To minimize manufacturing costs, in some embodiments the fluid energy converter 100 uses the flat foil 170 over the entire length of the blade 10. In other applications, such as large wind turbines, the fluid energy converter 100 uses the fluid foil 172 over the entire length of the blade 10. In other applications involving wind turbines, the fluid energy converter 100 can use two, three, four, or more airfoils over the length of the blade 10 to account for changes in angular velocity at different areas of the blade 10. The different functions that the front section 12 and the back section 22 perform may call for different configurations of the foils 170, 172, 174. For many wind turbines, SG6040, NACA 4412 or NACA 4415, for example, are acceptable airfoils although many different blades can be used. SD2030 is a good choice for small wind turbines.

Still referring to FIGS. 1-5C, in some embodiments, the chord length of the blades 10 is about 6% of the diameter of the rotor 1. The optimal chord length will vary with changes in the Reynolds number, diameter of the rotor 1, velocity of the fluid, type of fluid, angular velocity, and whether the fluid energy converter 100 converts kinetic energy to rotational energy or, conversely, uses mechanical rotational energy to impart kinetic energy to a fluid. In some embodiments, the chord length will be shorter on the back section 22 than the front section 12, while in other embodiments the chord length will be longer on the back section 22 than the front section 12. In some embodiments, the chord length of the front section 12 and the back section 22 decreases in length, or tapers 10 degrees, from the hubs 34, 44 to the tip 18. In other embodiments, the chord length is longer at the hubs 34, 44 and follows a non-linear taper toward the tip 18. Generally, when a non-linear taper is used the chord length increases gradually moving from the tip 18 toward the middle of the front section 12 and back section 22, and increases rapidly from the middle of the sections 12, 22 to the hubs 34, 44, respectively.

In some embodiments, the fluid energy converter 100 suffers little to no tip loss because the tips 18 have a tangential pitch which not only produces power but also prevents fluid from escaping around the tip 18. Some embodiments of the rotor 1 take advantage of this phenomenon by utilizing a reverse taper where the chord length is longest at the tips 18 and decreases toward the hubs 34, 44, respectively. Depending on the application, the front section 12 and the back section 22 may not have the same taper, and the back section 22 can have a taper while the front section 12 has a reverse taper. In embodiments where the front and back sections 12, 22 taper in the same direction, the optimal angle of the tapers can be different. In still other embodiments, neither the front section 12 nor the back section 22 tapers the chord length. This can be for manufacturing reasons, such as stresses on the blades 10, rather than aerodynamic or hydrodynamic efficiency. Cost can also be a factor, because in some applications it is simpler to manufacture the blades 10 without tapering the chord length.

Referring to FIGS. 1, 2, and 3, the nacelle 50 will now be described. The nacelle 50 can be a generally cylindrical, streamlined shape with a hollow interior that houses the power train 80, including the gearbox 82, the high speed shaft 86, and the motor/generator 88. In embodiments where the fluid energy converter 100 captures power in a moving fluid, such as a wind turbine or water turbine, the gearbox 82 can be a speed increaser, which increases the revolutions per minute (rpm) and decreases the torque of the rotor 1 into the generator 88. If the fluid energy converter 100 is used to move, compress, or accelerate a fluid and operate as a compressor or pump, the gearbox 82 can be a speed reducer, driven by the motor 88, that reduces rpm and increases torque to the rotor 1. The gearbox 82 can achieve speed increasing or speed decreasing capability by the use of multiple gears, traction rollers, variable speed changers, or any other suitable method. In some embodiments, the motor/generator 88 is configured to operate at the same or similar rpm as the rotor 1 and the gearbox 82 is not used.

In some embodiments, the nacelle 50 is a stationary component that is rigidly connected to the shaft 28 by fasteners, welding, an interference fit, or any other suitable method. The nacelle 50 can be built from any suitable materials, but generally materials with a high strength to weight ratio are preferable. Carbon fiber, fiberglass and polyester or epoxy resin, metal such as sheet aluminum, plastic and other materials can be used to construct the nacelle 50. In some embodiments, the nacelle 50 incorporates multiple helical vanes 52 to direct a fluid to flow in a desired direction. The helical vanes 52 are often made of the same material as the nacelle 50 and in some embodiments are formed integrally with the nacelle 50. For example, the nacelle 50 and the helical vanes 52 can be cast, injection molded, or rapid prototyped as one part. In other embodiments, the helical vanes 52 are attached to the nacelle 50 using standard fasteners, adhesive, or by welding.

On a first end, the nacelle 50 can be rigidly attached to a front coupler 85 using standard fasteners, by welding, or with an interference fit. The front coupler 85 can be a tubular component with a flange on one end, and in some embodiments, the front coupler 85 has through holes so that fasteners can be used to attach the front coupler 85 to the nacelle 50. A front bearing 38, which in some embodiments is a needle roller bearing, is positioned over the front coupler 85 and inside the front hub 34, to allow low friction rotation of the blades 10. At a second end, the nacelle 50 can be attached to the shaft 28, which can be a hollow cylinder that supports the structure of the rotor 1 and serves to route power lines and other cables through its interior. The shaft 28 can be rigidly attached to the nacelle 50 with fasteners, welding, an interference fit, or any other method commonly known. A back bearing 48, which in some embodiments is a needle roller bearing, can be positioned over the shaft 28 and inside the back hub 44, to allow low friction rotation of the back blades 40.

Still referring to FIGS. 1, 2, and 3, a power flow of the fluid energy converter 100 is described. In a wind turbine, windmill, water turbine, or other application where the fluid energy converter 100 converts kinetic energy in a fluid stream to rotational energy, torque and speed produced from the fluid contacting the blades 10, is transferred, in some embodiments, to the nose cone 36. The nose cone 36 can be domed- or cone-shaped and rigidly attaches to the front hub 34 using standard fasteners. In one embodiment, the nose cone 36 includes a counter bore adapted to accept a low speed shaft 84. In some embodiments, the low speed shaft 84 and the counterbore of the nose cone 36 are splined to provide torque transfer between the nose cone 36 and the low speed shaft 84. In other embodiments, the nose cone 36 can have a square hole, be keyed, welded, attached with fasteners, or any other suitable method, to the low speed shaft 84. The low speed shaft 84 can be a generally cylindrical rod that engages and rotates the input of the gearbox 82, and is fastened using fasteners or another suitable method.

The gearbox 82 preferably increases speed and lowers torque, and the output of the gearbox 82 can be attached to the high speed shaft 86, which attaches at a first end to the gearbox 82 with fasteners, splined, keyed, welded, pinned, or another method. The high speed shaft 86 can be a generally cylindrical rod that in some embodiments has a diameter that is smaller than the diameter of the low speed shaft 84 because the high speed shaft 86 transfers less torque. The high speed shaft 86 in some embodiments is flanged at a second end, and the flange has holes to allow fastening the high speed shaft 86 to the generator 88. The generator 88 can be an electromotive device commonly known which converts rotating mechanical energy into electrical energy. In some embodiments, the generator 88 is of the permanent magnet type, and the electricity that the generator 88 produces is routed with electrical wires or cables from the generator 88, through the hollow shaft 28, through a radial slot of the hollow shaft 28, into the tail body 66, through a hinge aperture 69, and through a hollow tower 70, where the electricity can be used. In embodiments where the fluid energy converter 100 is a compressor or pump, power flow is reversed, and electricity rotates the motor 88, while the gearbox 82 used is a speed reducer.

Still referring to FIGS. 1, 2, and 3, in some embodiments, such as a wind turbine or windmill, the fluid energy converter 100 includes a tail 60 configured to keep the rotor 1 pointed into the wind during changes in wind direction. In some embodiments, the tail 60 has four tail vanes 62, while in other embodiments 1, 2, 3, 4, 5, or more tail vanes 62 can be used. A tail shaft 64, generally a cylindrical rod, connects the tail 60 to the tail body 66. Preferably, a material with a high strength to weight ratio is used to construct the tail 60 components; such a material can be aluminum, titanium, carbon fiber, fiberglass and polyester or epoxy resin, or plastic. In some embodiments the tail vanes 62, tail shaft 64, and tail body 66 are cast, injection molded, rapid prototyped, or machined as one part.

In some embodiments, the tail body 66 has at least two cavities, including one to accept insertion of the shaft 28. The shaft 28 can be rigidly attached to the tail body 66 by using fasteners, welding, adhesive, an interference fit, or any other suitable method. The tail body 66 also has hinge pin holes 68 which have an axis that is perpendicular to the shaft 28, and lie on a plane parallel with the surface upon which the tower base 72 rests. The hinge pin holes 68 allow insertion of hinge pins (not shown) which are pressed into the tail body 66 with an interference fit. A second cavity in the tail body 66 accepts insertion of a hinge 67, which can be an interface between the tail body 66 and the tower 70; the hinge 67 allows the rotor 1 to be pitched and yawed.

The hinge 67 can be a strong, durable component that in some embodiments is made from steel or aluminum. In some embodiments, where the fluid energy converter 100 is small and/or the loads are light, the hinge 67 can be made from molded plastic, such as glass filled nylon, or a composite. The hinge 67 includes a counterbore which has an axis that is perpendicular to the axis of the shaft 28 and has an inside diameter slightly larger than the diameter of the tower 70 at its uppermost portion. A tower bearing 78, which in some embodiments is a needle thrust bearing, has an outside diameter that is approximately the same as the diameter of the uppermost portion of the tower 70, and is positioned inside the counter bore of the hinge 67 between the tower 70 and the hinge 67. The tower bearing 78 provides low friction yawing of the rotor 1. In one embodiment, the hinge 67 has two blind holes near its uppermost portion to allow insertion of the hinge pins 65 which are inserted through the hinge pin holes 68. The hinge pin holes 68 are preferably of a diameter slightly larger than the hinge pins 65 to allow the hinge pins 65 to rotate freely. In some embodiments, the tail 60 is not used and, instead, a commonly known yaw drive is used to control the yaw of the rotor 1 and maintain a desired orientation of the rotor 1 with respect to a fluid stream.

Theoretical descriptions of various modes of power extraction by the fluid energy converter 100 follow. Actual performance of any given embodiment of the energy converter 100 and/or rotor 1 is governed by a multiplicity of factors; hence, the following descriptions of operational principles are to be understood as generalized, theoretical, and/or not limiting upon the inventive embodiments of the devices and their methods of use described herein, unless otherwise specifically stated.

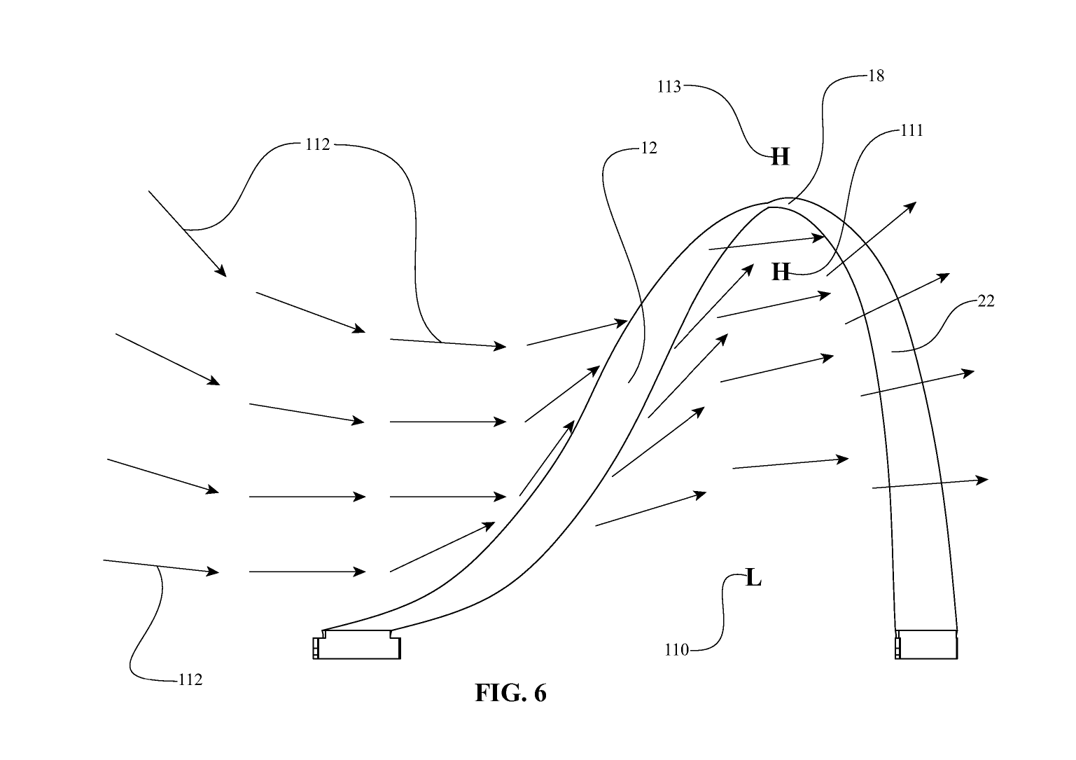

Referring now to FIGS. 1 and 6, a pressure differential effect through the rotor 1 is described. FIG. 6 shows a schematic of the rotor 1 in a flowing fluid 112, where the direction of the flow of fluid 112 is denoted by arrows. As the fluid 112 contacts the front section 12 of the blades 10 when the rotor 1 is rotating, the fluid 112 is directed radially away from the center of the rotor 1. The effect of this phenomenon is that an interior high pressure area 111 forms on the inside surfaces of the blade tips 18, and an interior low pressure area 100 forms in the center of the rotor 1. The interior low pressure area 110 causes the fluid 112 at the front of the rotor 1 to accelerate. When the fluid 112 is air, the available power increases by the cube of the increase in wind velocity.

By way of example, when the rotor 1 turns (for example, in a 10 meter per second wind), the interior low pressure area 110 causes the fluid 112 to accelerate through the rotor 1. If the interior low pressure area 110 causes the rotor 1 to draw fluid 112 from an area surrounding the rotor 1 having a diameter that is 20% larger than the diameter of the rotor 1, the effective area of the rotor 1 will increase by 44%. This causes the speed of the fluid 112 through the rotor 1 to increase by 44%, and the amount of power available in the fluid 112 increases about 3 times. This increase in available power causes the angular velocity of the rotor 1 to increase, which more rapidly pushes the fluid 112 radially away from the center of the rotor 1. The interior low pressure area 110 increases in size as the fluid 112 is more strongly directed radially away from the center of the rotor 1. As the interior low pressure area 110 enlarges, the fluid 112 flowing through the rotor 1 accelerates more rapidly, increasing available power. The result is more efficient energy capture for the fluid energy converter 100 when used as a wind turbine. It should be noted that this phenomenon can also occur in other applications of the fluid energy converter 100, such as compressors, propellers, pumps, and water turbines.

Still referring to FIGS. 1 and 6, as fluid 112 is drawn from an effective area greater than the area defined by the diameter of the rotor 1, the fluid 112 adjacent to the fluid 112 approaching the front section 12 of the blades 10 is affected through viscous interaction and follows a similar path. The result is that the fluid 112 is compressed onto the outside surface of the tip 18, creating an external high pressure area 113, which surrounds the rotor 1. The internal high pressure area 111 and the external high pressure are 113 on the tips 18 increase the density of the fluid 112 that interacts with the power producing surfaces of the rotor 1, resulting in further increases in the amount of power that the fluid energy converter 100 can extract. The result is a more efficient energy capture for the fluid energy converter 100 when it is used as a wind turbine. This phenomenon can also occur in other applications of the fluid energy converter 100, such as compressors, propellers, pumps, and water turbines.

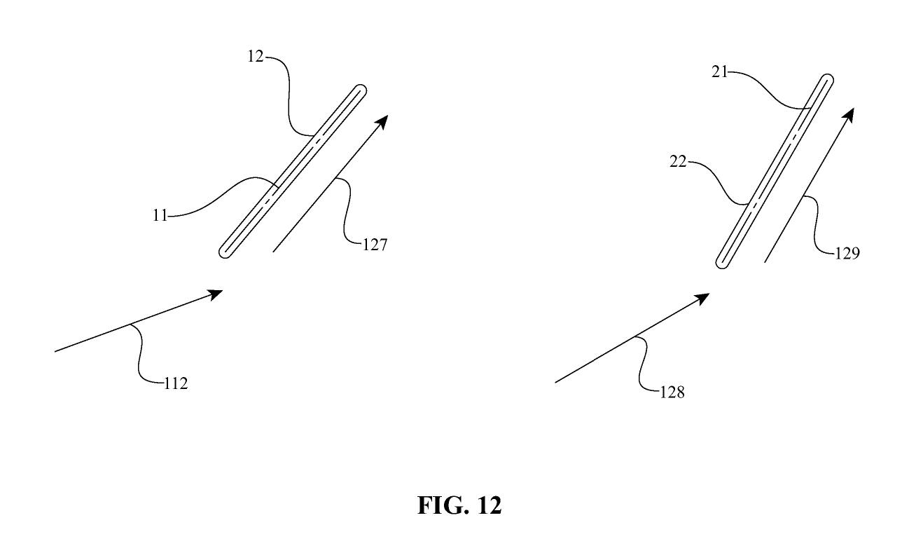

Referring now to FIG. 12, fluid dynamic properties of the rotor 1 are described. In some applications fluid 112 is directed, or moved within the rotor 1 to maximize energy extraction from the kinetic energy in the fluid 112. FIG. 12 shows a schematic section view of a blade 10 viewed from the top. Both the front section 12 and back section 22 of the blade 10 utilize a flat foil 170 in the embodiment depicted. When fluid 112 contacts the front section 12, the fluid 112 is bent into a fluid flow 127, that is, fluid 112 changes direction after it passes by the front section 12, if the front section 12 has an angle of attack relative to the flow of the fluid 112. As the front section fluid 127 moves past the front section 12, the fluid 127 changes direction and moves in a direction substantially parallel with the front section chord 11. After passing the front section 12 of the blade 10, the interior fluid 128 also rotates in a direction which is substantially opposite the direction of rotation of the rotor 1. This interior fluid 128 then contacts a back section 22 of one of the blades 10, from an angle that is different than the angle at which the fluid 112 contacts the front section 12. This results because the front section 12 has altered the direction of the flow of the interior fluid 128. Additionally, the interior fluid 128 is also moving radially out toward the tip 18. As the interior fluid 128 continues through the interior of the rotor 1 it is affected by viscous interaction with surrounding fluid 112 that has a component of its movement rotating in the same direction as the rotor 1. Thus, when the interior fluid 128 reaches the back section 22, in some embodiments the fluid 128 is not flowing in the same direction as the front section fluid 127. To create the correct of angle of attack for the interior fluid 128, the back section 22 is set at a pitch which is different in some embodiments than the front section 12 pitch. In some embodiments the pitch of the back section 22 is 10 degrees less than the pitch of the front section 12, although the pitch of the back section 22 will vary with the type of fluid 112, angular velocity of the fluid energy converter 100, purpose of the fluid energy converter 100, and velocity of the fluid 112.

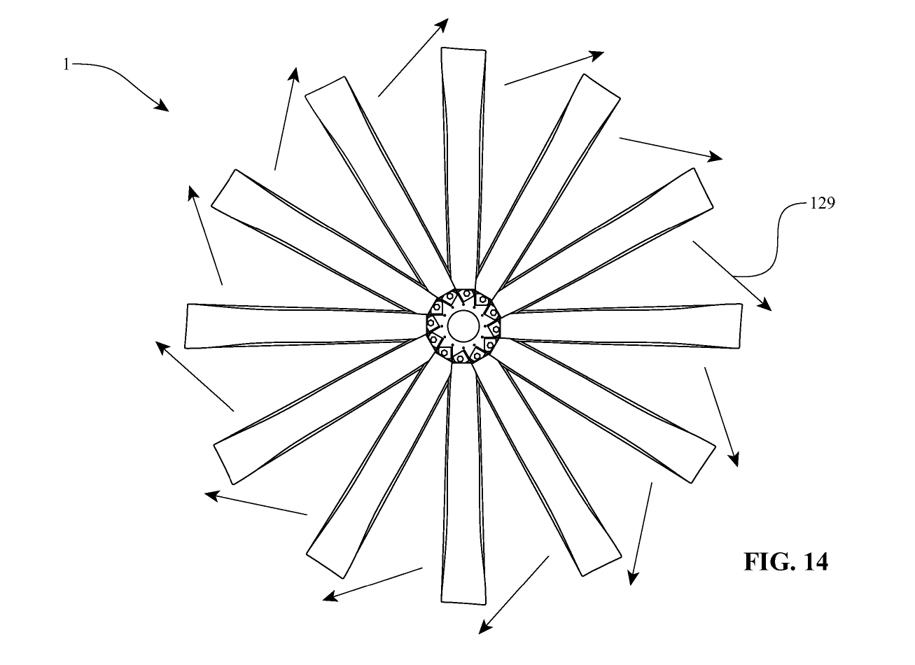

Referring now to FIGS. 12 and 14, as the back section fluid 129 passes by the back section 22, its direction is again altered due to its interaction with the back section 22. The back section fluid 129 moves in a direction roughly parallel with the back section chord 22, which in some embodiments can be set at a pitch near 0 degrees. Thus, the back section fluid 129 moves in a direction that is substantially radially away from the center of the rotor 1. In FIG. 14, the direction of the back section fluid 129 is shown from behind the rotor 1 as the back section fluid 129 leaves the rotor 1. A component of the back section fluid 129 is moving radially away from the center of the rotor 1. This action further deepens the internal low pressure area 110, increases the internal high pressure area 111, and increases the external high pressure area 113, shown in FIG. 6.

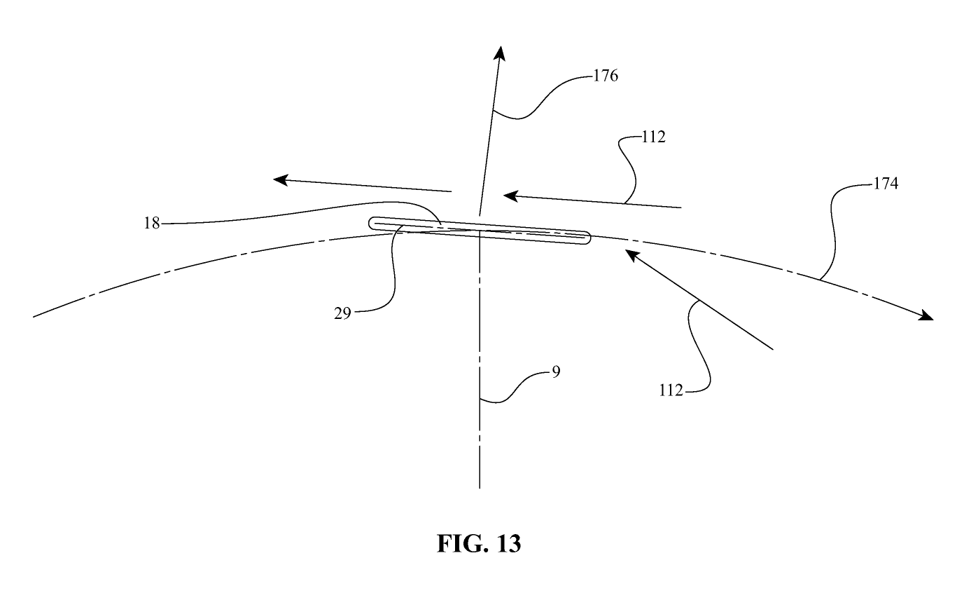

Referring to FIG. 13, the effect of fluid 112 at the tip 18 is described. FIG. 13 is a schematic cross sectional front view of the profile of the tip 18. In the embodiment shown, the tip 18 has a flat foil 170 described in FIG. 5B. The rotation direction 174 is shown by the hatched curved arrow and the rotor radius 9 is shown by the hatched line. It can be seen that the tip chord 29 is not 90 degrees, or tangent, to the rotor radius 9, but has a tangential pitch which is −6 degrees, in this example. In some embodiments, as the fluid 112 is directed radially toward the tip 18 by the front section 12 and as the fluid 112 passes through the rotor 1, the fluid 112 reaches the tip 18. In some embodiments the tip 18 helps prevent the fluid 112 passing by the tip 18 from escaping the influence of the rotor 1 and minimizes tip loss. The tip 18 can alter the radial movement of the fluid 112 so that it transfers its energy to the rotor 1. A negative tangential pitch will also create tangential lift 176, the direction of which is denoted with an arrow, which has a small vector in the rotation direction 174, adding power to the rotor 1.

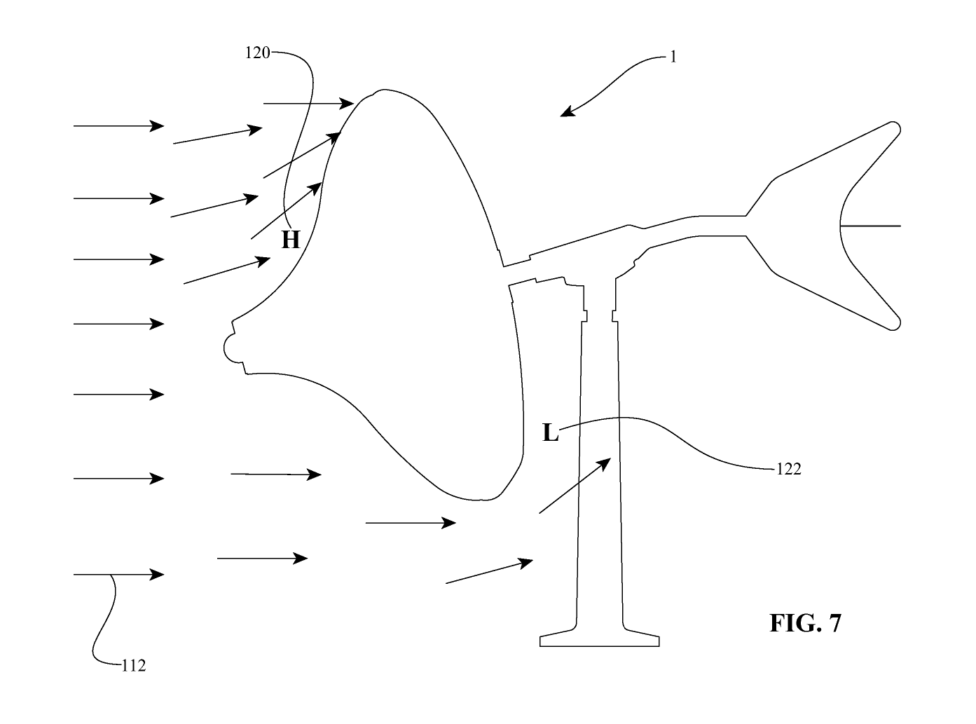

Referring to FIGS. 1, 6, 7, and 8, the effect of pitching the rotor 1 is explained. Pitching, or tilting the rotor 1 vertically, causes changes in pressure both inside and outside of the rotor 1. If the rotor 1 is pitched down as in FIG. 7, a top high pressure area 120 forms on the top half near the front of the rotor 1 on its outside surface. In embodiments where the fluid energy converter 100 is used with compressible fluids 112, the internal low pressure area 110 rises as it exits the back of the rotor 1 because the exiting fluid 112 is less dense than the surrounding exterior fluid. In this case, the fluid 112 in the top high pressure area 120 accelerates toward the internal low pressure area 110 behind the rotor 1 and increases the available energy that the fluid energy converter 100 can capture. Similarly, a bottom low pressure area 122 forms near the bottom and back of the rotor 1. In some embodiments, the rotor 1 is pitched down 20 degrees, although depending on the application, a pitch of between 1 and 30 degrees can be used during normal operation.

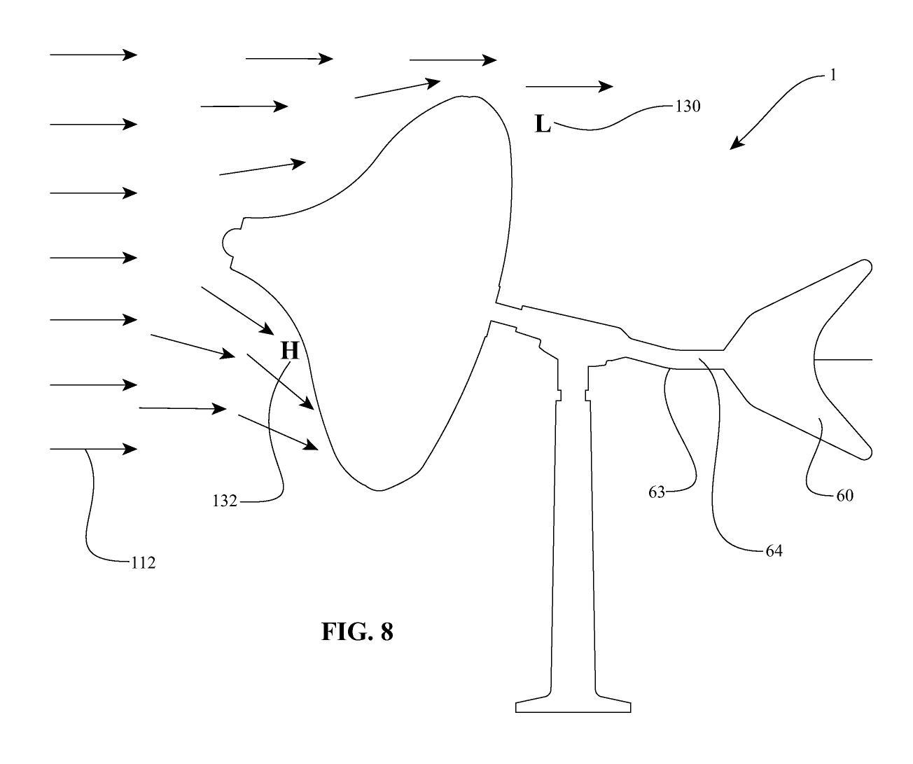

FIG. 8 shows the rotor 1 pitched up about 20 degrees, which creates a top low pressure area 130 on the top and back of the rotor 1. The top low pressure area 130 and the bottom high pressure area 132 produce lift, which is advantageous in some embodiments. For example, in some embodiments it is preferable to make the rotor 1 as light as possible, and situations can develop when the rotor 1 becomes weightless as the rotor 1 is pitched up. Although the rotor 1 is pitched up about 20 degrees, in other embodiments the pitch angle can vary between 1 and 30 degrees during normal operation. In some embodiments, the tail shaft 64 includes a tail bend 63 to maintain a desired pitch angle relative to the flow of the fluid 112. In other embodiments a pitch drive is used, which is similar to a yaw drive, to control the pitch angle of the rotor 1.

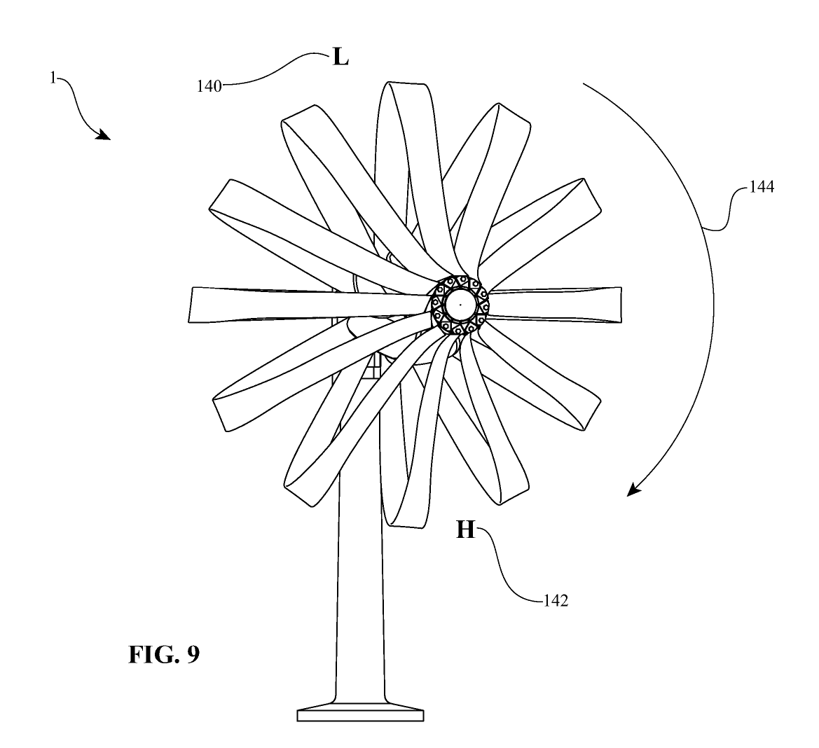

Referring to FIGS. 8, 9, and 10, the effects of yawing the rotor 1 are explained. In FIG. 9 the rotor 1 is yawed 16 degrees in a first direction so that the fluid 112 flows in a direction substantially with the rotation direction 144 over the top of the rotor 1. At this yaw orientation, a yaw top low pressure area 140 develops on the top of the rotor 1 which produces lift. Similarly, a yaw bottom high pressure area 142 forms on the bottom of the rotor 1 due to the blades 10 moving in a direction which is not in the same direction as the fluid 112. This also produces lift which makes the rotor 1 lighter, and in some embodiments, the rotor 1 can be made lighter than air by using this lift mechanism. In some embodiments, the tail shaft 64 includes a tail bend 63 to maintain the yawing of the rotor 1 at a desire orientation relative to the fluid 112. Although in this example the rotor 1 is yawed 16 degrees in a first direction, in other embodiments the yaw angle can vary between 1 and 30 degrees during normal operation.

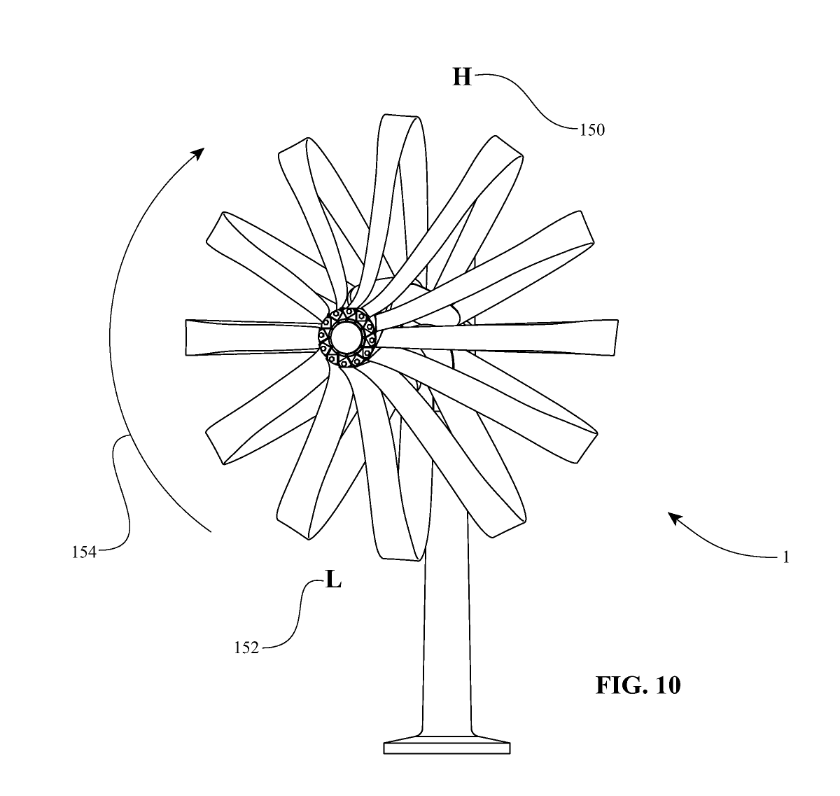

Still referring to FIGS. 8, 9, and 10, in FIG. 10 the rotor 1 is yawed in the opposite, or a second, direction. At this yaw orientation, a yaw top high pressure area 150 forms on the top of the rotor 1 and a yaw bottom low pressure area 152 is produced on the bottom of the rotor 1. In this situation, the rotation direction 154 causes a component of the blades 10 to move against the fluid 112 at the top of the rotor 1, and substantially with the fluid 112 at the bottom of the rotor 1. In embodiments where the fluid energy converter 100 is used with a compressible fluid 112, the internal low pressure area 110 rises as it exits the back of the rotor 1 because the exiting fluid 112 is less dense than the surrounding gas. In this case, the yaw top high 150 causes acceleration of the wind 112 toward the internal low pressure area 110 behind the rotor 1, and increases the available energy that the fluid energy converter 100 can capture. In some embodiments, the rotor 1 is yawed 16 degrees in the second direction, while in other embodiments the rotor 1 is yawed between 1 and 30 degrees.

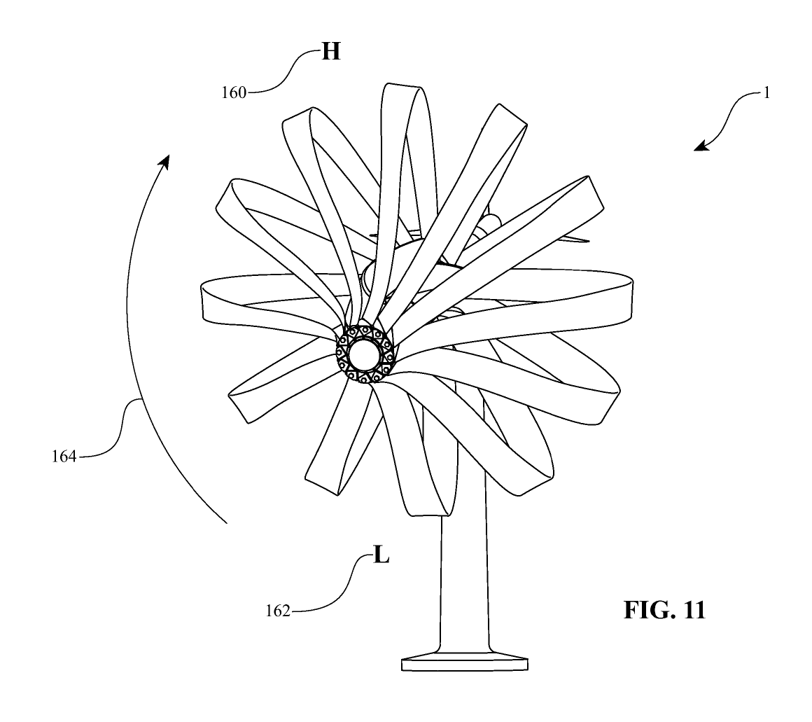

Referring now to FIG. 11, the rotor 1 is both pitched down 15 degrees and yawed 14 degrees, for example, to maximize the pressure differences that can be produced. Depending on the application, the pitch angle of the rotor 1 can vary between 1 and 30 degrees and the yaw angle can vary between 1 and 30 degrees. The combination of pitching and yawing the rotor 1 produces a yaw-pitch high pressure area 160 on the top of the rotor 1 and a yaw-pitch low pressure area 162 underneath the rotor 1. In one embodiment, the blades 10 are formed to be of a left hand orientation, and the rotation direction 164 of the rotor 1 is clockwise when viewed from the front. The same pressure differences result when the blades 10 are right hand, the rotor 1 is pitched down, but the yaw is in the first direction. With the blades 10 in a left hand orientation and the rotor 1 pitched up and the yaw in a first direction, the pressure differences on the top and bottom of the rotor 1 reverse, and a low pressure results on the top, and a high pressure is produced underneath the rotor 1. Generally, when the rotor 1 is both pitched and yawed to maximize the pressure differences that can be produced, the rotor 1 pitch angle will be less than if it were only pitched and not also yawed, and the rotor 1 yaw angle will be less than if it were only yawed and not also pitched.

In some embodiments such as wind turbines, because the structure of the rotor 1 can be configured to be stronger than the structure of commonly used wind capturing technologies, the rotor 1 can be used at higher wind speeds than current technologies. In very high winds, the rotor 1 can be yawed or pitched more than in normal operation to reduce wind flow into the rotor 1 so that the fluid energy converter 100 can still operate without damage to the power train 80 and generator 88.

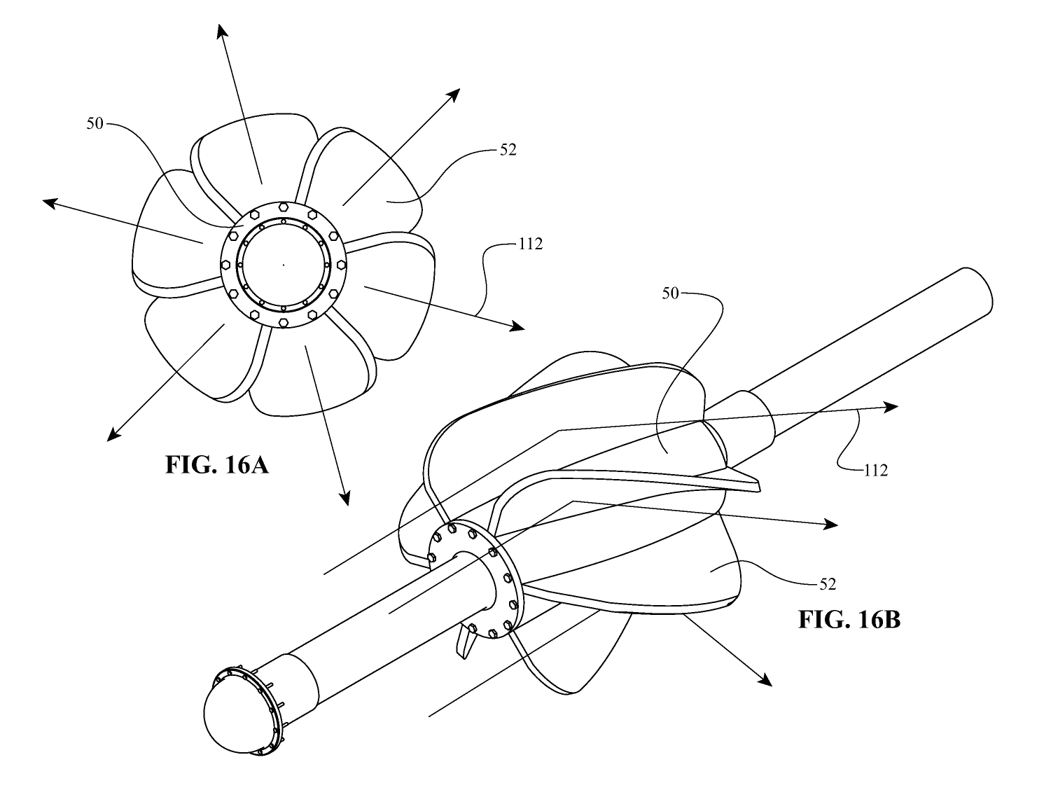

Referring now to FIGS. 1, 16A, and 16B, the flow of fluid 112 over and around the nacelle 50 is described. In one embodiment, the nacelle 50 is configured to direct fluid 112 in a selected direction by configuring the nacelle vanes 52 in a desired shape and position. In some embodiments, the nacelle vanes 52 have a helix that is opposite to the pitch of the blades 10. For example, if the blades 10 are left hand, the nacelle vanes 52 will be right hand so that the fluid 112 will be directed to flow and rotate in the same direction as the rotation of the rotor 1 as seen in FIG. 16B. The nacelle vanes 52 can also be configured to direct fluid 112 radially away from the center of the rotor 1 as seen in FIG. 16B, which increases the internal low pressure area 110 and increases the internal high pressure area 111 and external high pressure a real 13. In some embodiments the pitch of the nacelle vanes 52 is less than the pitch of the blades 10, but depending upon the application, the pitch of the nacelle vanes 52 can be equal to or higher than the pitch of the blades 10. In some embodiments, the number of nacelle vanes 52 is half the number of blades 10, but the number of nacelle vanes 52 can be more or less than the number of blades 10.

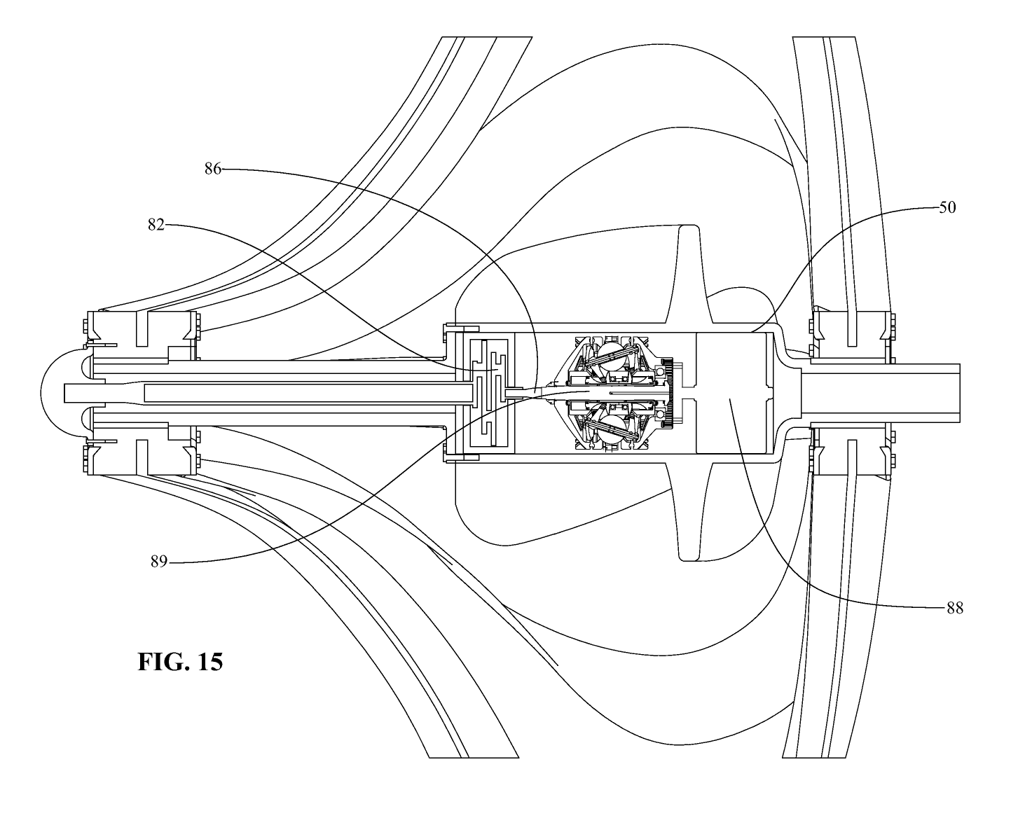

Referring to FIG. 15, in one embodiment the nacelle 50 can include a continuously variable transmission (CVT) 89, which can be placed between the gearbox 82 and the generator 88. In some embodiments, the inside of the nacelle 50 can be the case of the CVT 89. In other embodiments the case (not shown) of the CVT 89 rigidly attaches to the nacelle 50. The input of the CVT 89 can be coupled to the high speed shaft 86 using a spline, key, fasteners, pins, or any other suitable method. In one embodiment, the output of the CVT 89 can be coupled to the generator 88 with fasteners which are inserted through holes in a flange of the generator 88 and threaded into tapped holes on the output of the CVT 89. The CVT 89 maintains a constant input speed into the generator 88, even as the velocity of the fluid 112 varies, by increasing the input rotational speed when the velocity of the fluid 112 is low and by reducing the input rotational speed when the velocity of the fluid 112 is high.

Referring now to FIGS. 1, 3, 4a, 4b, 4c, and 13, flexing of the blades 10 is described. In some embodiments, changes in the velocity of the fluid 112 and/or angular velocity of the rotor 1 can cause changes in the pitch of the front section 12, tangential pitch at the tip 18, and pitch of the back section 22 of the blades 10. In some embodiments, such as wind turbines, it is advantageous to alter these pitches with changes in the velocity of the fluid 112 and/or angular velocity of the rotor 1. In some embodiments, the blades 10 can be made to flex or bend so that these pitches decrease with an increase in the velocity of the fluid 112 and/or an increase in angular velocity. Flexing of the blades 10 can be accomplished by constructing the blades 10 of a flexible material, such as sheet metal, plastic, a composite, or other suitable material. The amount of flex in the blades 10 can be controlled by varying the thickness of the material and the length of the chord. As the velocity of the fluid 112 increases, it produces an increase in pressure on the blade 10 surface, especially at the front section 12. If the front section 12 is pushed back toward the back section 22 by the increased pressure of the fluid 112 on the front section 12 surface, the pitch of the front section 12, the tangential pitch at the tip 18, and the pitch of the back section 22 can all be configured to decrease. Typically, an increase in the velocity of the fluid 112 will cause an increase in angular velocity of the rotor 1. In many applications, increases in angular velocity will require a decrease in the pitch of the front and back sections 12, 22, and tip 18, to maintain optimum efficiency.

As the tip 18 rotates faster due to an increase in the velocity of the fluid 112, more pressure will be applied to its surface from the fluid 112, and if the blade 10 is flexible, it will be pushed tangentially back opposite the rotation direction 174 of the rotor 1. This will decrease the tangential pitch at the tip 18, which in some embodiments is desirable.

Still referring to FIGS. 1, 3, 4a, 4b, 4c, and 13, in some embodiments the power train 80 is attached to the back hub 44, and the front hub 34 rotates freely. In such embodiments, the front hub 34 will rotate in advance of the back hub 44, pulling it along, due to the fact that the back hub 44 must overcome the resistance of the power train 80 torque. This rotation by the front hub 34 some number of degrees in advance of the back hub 44 typically increases when fluid 112 velocity and/or angular velocity increases. This increase in the angle of the front hub 34 relative to the back hub 44 will cause the pitches of the front and back sections 12, 22, and the tangential pitch at the tip 18, to decrease.

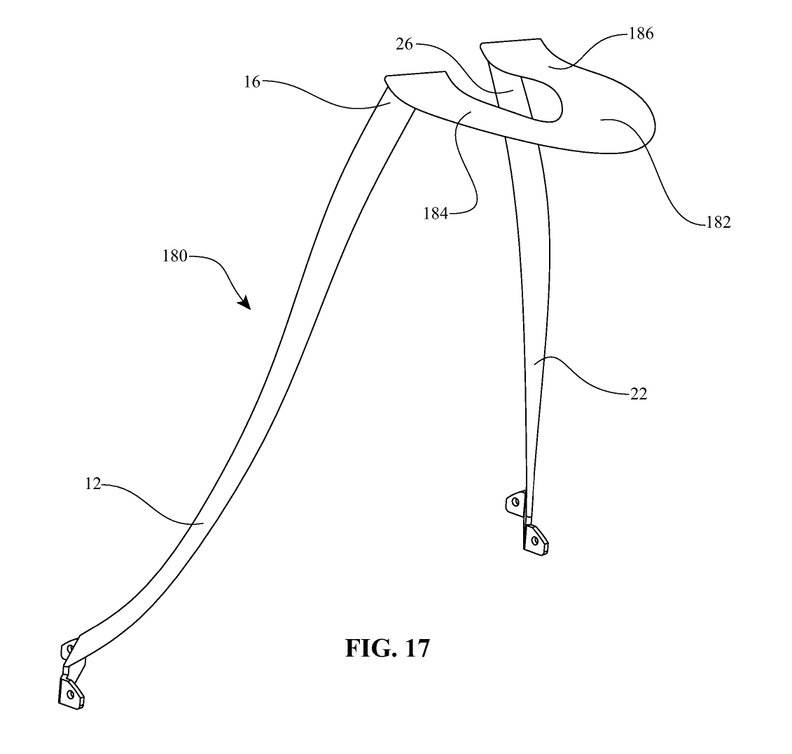

Referring now to FIG. 17, an alternative blade 180 of the fluid energy converter 100 is described. For the purpose of simplicity, only the differences between the blade 10 and the blade 180 will be described. The blade 180 includes a tip flap 182, which is a portion of the blade 180 at the longest radius of the blade 180, that is folded over at bends in the front transition 16 and back transition 26, so that the tangential pitch of the tip flap 182 is the same as the tangential pitch of the tip 18 of the blade 10. During rotation of the rotor 1, the fluid 112 applies pressure against a surface of the tip flap 182 which faces the shaft 28 of the rotor 1. This pressure on the interior surface of the tip flap 82 typically increases with an increase in angular velocity of the rotor 1. The tip flap 182 can be designed to flex or bend in response to the pressure applied by the fluid 112. The flex of the tip flap 182 can be configured so that as the pressure of the fluid 112 increases in response to an increase in angular velocity of the rotor 1, the tangential pitch of the tip flap 182 decreases.

Still referring to FIG. 17, the tip flap 182 includes the front flap 184 and the back flap 186. The front flap 184 is the front portion of the tip flap 182, that portion which is attached to the front transition 16, and the back flap 186 is the back portion of the tip flap 182, the portion which is attached to the back transition 26. In addition to having a tangential pitch previously described, the tip flap 182 can have a pitch which offsets it relative to the axis of the shaft 28, herein called the axis pitch. The axis pitch, which is the angle created between the axis of the shaft 28 and the axis pitch of the tip flap 182, can be designed to create lift toward the front or back of the rotor 1. A negative axis pitch of the tip flap 182 will produce a blade 10 where the front edge of the front flap 184 is closer to the shaft 28 than the back edge of the back flap 186. A positive axis pitch of the tip flap 182 will produce a blade 10 where the front edge of the front flap 184 is radially farther from the shaft 28 than the back edge of the back flap 186. In some embodiments, the tip flap 182 has an axis pitch of −4 degrees. In other embodiments, the tip flap 182 has a positive axis pitch which is designed to capture fluid 112 and cause a flexible tip flap 182 to bend radially outward in response to increases in the velocity of the fluid 112, decreasing the tangential pitch of the tip flap 182. In some such embodiments the tip flap 182 can also be configured to twist so that the tip flap 182 moves closer to the back of the rotor 1 in response to an increase in fluid 112 velocity. This also has the effect of twisting the front section 12 and the back section 22, reducing their pitches in response to an increase in fluid velocity 112.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

1. A rotor for a fluid energy converter, the rotor comprising:
a longitudinal axis;
a front rotatable hub coaxial with the longitudinal axis;
a back rotatable hub coaxial with the longitudinal axis;
a plurality of blades, each blade comprising a back end, a front end, a front section, a tip, and a back section;
wherein the blades are arrayed angularly about the longitudinal axis; and
wherein each blade is attached at the front end to the front hub and attached at the back end to the back hub.

2. The rotor of claim 1, wherein the fluid energy converter comprises a horizontal axis wind turbine.

3. (canceled)

4. The rotor of claim 1, wherein the front section comprises a pitch higher than a pitch of the back section.

5. The rotor of claim 1, wherein the rotor is adapted to produce areas of high and low pressure.

6. (canceled)

7. (canceled)

8. (canceled)

9. The rotor of claim 5, wherein the low pressure area begins near the front section of the blades, and wherein the difference between the low pressure area and a surrounding pressure increases toward the back section of the blades.

10. The rotor of claim 5, wherein the high pressure area begins near the front section of the blades, and wherein the difference between the high pressure area and a surrounding pressure increases toward the back section of the blades.

11. The rotor of claim 5, where the rotor creates a pressure gradient between an area near the back section of the blades around the longitudinal axis and an area near where the fluid approaches the rotor.

12.-16. (canceled)

17. The rotor of claim 5, wherein the fluid comprises a gas and is compressed against the exterior surface of the blade tips.

28.-23. (canceled)

24. A rotor for a fluid energy converter, the rotor comprising;
a longitudinal axis;
a front rotatable hub coaxial with the longitudinal axis;
a back rotatable hub coaxial with the longitudinal axis;
a plurality of blades, each blade attached at a front end to the front hub and attached at a back end to the back hub, the blades positioned radially around the longitudinal axis, and wherein each blade has a front section, a tip, and a back section; and
wherein the chord of the tip cross section is at an angle relative to the tangent of the rotor radius.

25. The rotor of claim 24, wherein the tip chord angle is negative.

26. The rotor of claim 25, wherein the tip chord angle is between −1 and −15 degrees.

27. The rotor of claim 24, wherein the tip chord angle is adapted to change with a change in the angular velocity of the rotor.

28. The rotor of claim 27, wherein the tip chord angle approaches zero as the angular velocity of the rotor increases.

29. The rotor of claim 27, wherein the blades are adapted to bend to produce changes in the tip chord angle.

30. The rotor of claim 29, wherein the bending of the blades increases with an increase in angular velocity of the rotor.

31.-65. (canceled)

66. A fluid energy converter rotor, comprising:
a longitudinal axis;
a rotatable front hub coaxial with the longitudinal axis;
a rotatable back hub coaxial with the longitudinal axis;
a shaft coaxial with the longitudinal axis;
at least three blades coaxial about the longitudinal axis, the plurality of blades comprising:
a front section, the front section attached at its root to the front hub;
a back section, the back section attached at its root to the back hub;
a tip, the tips of the blades forming the largest diameter of the rotor; and
wherein the profile of the tip from its junction root to the tip forms a convex curve.

67. (canceled)

68. (canceled)

69. The fluid energy converter of claim 66, wherein the blades are made from a material with a substantially uniform thickness.

70. (canceled)

71. The fluid energy converter of claim 69, wherein the cross sectional profile of the blades comprises a flat profile.

72. The fluid energy converter of claim 69, wherein the cross sectional profile of the blades comprises a curved profile.

73. The fluid energy converter of claim 66, wherein the fluid in the interior area of the rotor rotates in a direction that is opposite to a direction of rotation of the rotor.

74.-85. (canceled)
